(19) United States
(12) Patent Application Publication
(10) Pub. No.: US 2024/0145818 A1
(43) Pub. Date: May 2, 2024

(54) BATTERY CELL AND LIQUID-COOLED BATTERY

(71) Applicant: Dr. Ing. h.c. F. Porsche Aktiengesellschaft, Stuttgart (DE)

(72) Inventors: Markus Göhring, Nufringen (DE); Benjamin Passenberg, Rutesheim (DE); Gorazd Balejik, Prag (CZ); Tim Schmidt, Freiberg am Neckar (DE)

(73) Assignee: Dr. Ing. h.c. F. Porsche Aktiengesellschaft, Stuttgart (DE)

(21) Appl. No.: 18/499,316

(22) Filed: Nov. 1, 2023

(30) Foreign Application Priority Data
Nov. 2, 2022 (DE) 10 2022 128 908.7

(51) Int. Cl. H01M 10/6567; H01M 10/613; H01M 10/647; H01M 50/474

(52) U.S. Cl. CPC H01M 10/6567; H01M 10/613; H01M 10/647; H01M 50/474

(57) ABSTRACT

A battery cell including a cell housing having a first side wall and a second side wall which is parallel to the first side wall. A projecting spacer structure which is formed by the respective side wall is provided on an outer side of the first side wall and/or on an outer side of the second side wall. A liquid-cooled battery includes a plurality of battery cells, which are stacked such that the second side wall of a first battery cell abuts the first side wall of an adjacent second battery cell and a spacer structure of the second side wall of the first battery cell and/or a spacer structure of the first side wall of the second battery cell form at least one respective intermediate space between two adjacent battery cells which is configured such that a cooling liquid (K) flows through the intermediate space during operation.

### CROSS-REFERENCE TO RELATED APPLICATION

This application claims priority to German Patent Application No. 10 2022 128 908.7, filed Nov. 2, 2022, the content of such application being incorporated by reference herein in its entirety.

### FIELD OF THE INVENTION

The present invention relates to a battery cell which includes a cell housing comprising a first side wall and a second side wall which is parallel to the first side wall. The present invention also relates to a liquid-cooled battery, in particular a liquid-cooled traction battery, which comprises a plurality of battery cells according to aspects of the invention.

### BACKGROUND OF THE INVENTION

A battery comprising a plurality of battery cells, which each comprise a first side wall and a second side wall that is parallel to the first side wall and are stacked such that the second side wall of a first battery cell and the first side wall of an adjacent second battery cell face one another, is known from WO 2015/132786A1, which is incorporated by reference herein. A separate spacer element is disposed between the opposite side walls of adjacent battery cells, against which the opposite side walls of the two adjacent battery cells rest, so that the adjacent battery cells are fixedly held in position by the spacer element. The spacer element is configured such that the spacer element between the two adjacent battery cells creates a plurality of intermediate spaces through which a cooling liquid flows during operation of the battery to cool the battery cells. The spacer elements consequently provide reliable positioning and at the same time enable efficient cooling of the battery cells. Due to the large number of spacer elements, however, the production of the described battery is relatively complex and therefore relatively costly.

### SUMMARY OF THE INVENTION

Described herein is a relatively cost-effective production of a battery with efficiently cooled battery cells.

The battery cell according to aspects of the invention comprises a generally multipart cell housing comprising a first side wall and a second side wall which is parallel to the first side wall, wherein the side walls are preferably formed by the same housing part of the cell housing. The cell housing encloses a cell chamber in which the active materials of the battery cell are disposed and which is sealed in an airtight manner. The cell housing is preferably configured in the shape of an elongated cuboid. The cell housing preferably comprises a housing part which is configured as a hollow profile and forms the two parallel side walls.

According to aspects of the invention, a projecting spacer structure which is formed by the respective side wall i.e., formed in one piece with the respective side wall, is provided on an outer side of the first side wall and/or on an outer side of the second side wall. The projecting spacer structure configured on the outer side of at least one of the two side walls forms at least one intermediate space between two battery cells of a battery which are disposed such that the second side wall of a first battery cell abuts the first side wall of an adjacent second battery cell, wherein a cooling liquid can flow through said intermediate space during operation of the battery. The at least one spacer structure therefore enables reliable positioning of the battery cells within the battery and at the same time efficient cooling of the battery cells during operation of the battery, without having to provide additional spacer elements for this purpose. The spacer structure formed in one piece with the side wall furthermore creates a relatively large outer surface area of the housing and thus enables a particularly efficient heat exchange with the cooling liquid that flows around the battery cell during operation of the battery.

The battery cell according to aspects of the invention comprising the spacer structure integrated in the cell housing therefore enables a relatively cost-effective production of a battery with efficiently cooled battery cells.

In a preferred embodiment of the battery cell according to aspects of the invention, the at least one spacer structure comprises a plurality of parallel ribs which form at least one elongated intermediate space between the side walls of adjacent battery cells through which liquid can flow axially. The spacer structure preferably comprises a plurality of ribs which form a plurality of elongated intermediate spaces between the side walls of adjacent battery cells through which liquid can flow axially. The elongated intermediate spaces enable a particularly uniform flow of cooling liquid between the side walls of adjacent battery cells and thus particularly efficient cooling of the battery cells.

The ribs are preferably configured parallel to a longitudinal axis of the battery cell, so that a housing part that forms the side wall comprising the spacer structure can be produced cost-effectively as an extruded profile.

In a preferred embodiment of the battery cell according to aspects of the invention, a first spacer structure is provided on the outer side of the first side wall and a second spacer structure is provided on the outer side of the second side wall, i.e., a spacer structure is provided on the outer sides of each of the two parallel side walls.

The ribs of the first spacer structure are preferably configured parallel to the ribs of the second spacer structure and the ribs of the first spacer structure and the ribs of the second spacer structure are disposed such that, in a parallel projection of the two spacer structures onto a projection plane which extends parallel to the outer sides of the two side walls, ribs of the first spacer structure are located between ribs of the second spacer structure. The interlocking ribs of the spacer structures of the adjacent battery cells prevent the battery cells from slipping in a transverse direction of the ribs, thus achieving a particularly reliable positioning of the battery cells.

Particularly efficient cooling of the battery cell, in particular of the active materials disposed within the cell housing, can be realized in that the two side walls in a preferred embodiment of the battery cell according to aspects of the invention are both made of a metal, i.e., a material having a relatively high thermal conductivity. The side walls being made of metal moreover creates a relatively robust cell housing.

A particularly cost-effective production of the battery cell according to aspects of the invention, and thus of a battery comprising a plurality of the battery cell according to aspects of the invention, is made possible in that, in a preferred embodiment of the battery cell according to aspects of the invention the two side walls are formed by a single housing part configured as an extruded profile. The extruded profile is preferably configured as a hollow profile having a rectangular cross-section, which overall forms four side walls of the cell housing.

According to aspects of the invention, a liquid-cooled battery comprises a plurality of the above-described battery cells according to aspects of the invention, wherein the battery cells are stacked such that the second side wall of a first battery cell abuts the first side wall of an adjacent second battery cell and a spacer structure of the second side wall of the first battery cell and/or a spacer structure of the first side wall of the second battery cell form at least one respective intermediate space between two adjacent battery cells which is configured such that a cooling liquid flows through said intermediate space during operation. It should explicitly be noted here that the features “first side wall” and “second side wall” are intended to be understood here in the sense of “the one side wall” and “the other side wall.” The first side wall of the first battery cell could therefore also rest against the second side wall of the second battery cell.

Integrating the spacer structure of the battery cells according to aspects of the invention into the cell housing makes it possible to produce the liquid-cooled battery according to aspects of the invention relatively cost-effectively, wherein the at least one intermediate space respectively configured between two adjacent battery cells by the at least one spacer structure makes it possible to achieve efficient cooling of the battery cells by means of a cooling liquid that flows through the at least one intermediate space during operation of the liquid-cooled battery.

### BRIEF DESCRIPTION OF THE DRAWINGS

A design example of the present invention will be described in the following with reference to the accompanying figures. The FIGs. show:

FIG. 1 a perspective illustration of a battery cell according to aspects of the invention,

FIG. 2 a plan view onto an end face of the battery cell of FIG. 1,

FIG. 3 a section of a parallel projection of spacer structures of the battery cell shown in FIG. 1 and FIG. 2,

FIG. 4 a schematic diagram of a liquid-cooled battery according to aspects of the invention with a battery cell stack which comprises a plurality of the battery cells shown in FIG. 1 and FIG. 2,

FIG. 5 a plan view onto an end face of the battery cell stack of FIG. 4, and

FIG. 6 an enlarged view of a section of the battery cell stack of FIG. 5 which shows intermediate spaces formed by spacer structures of adjacent battery cells of the battery cell stack.

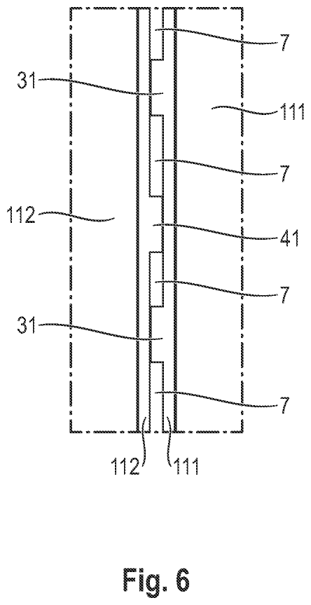

### DETAILED DESCRIPTION OF THE INVENTION

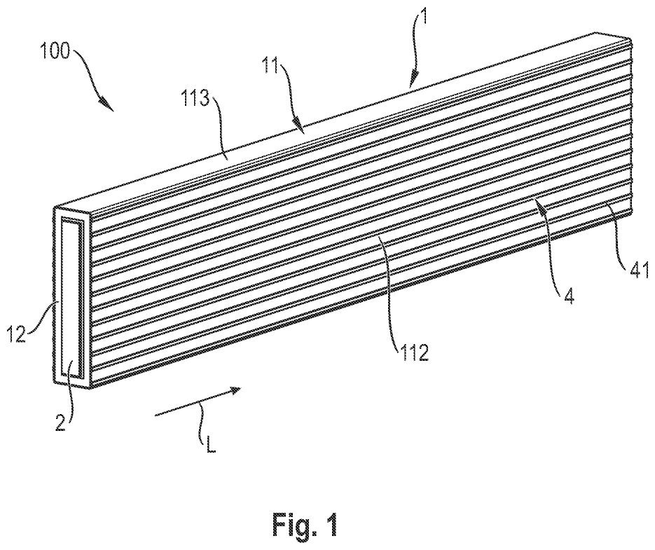

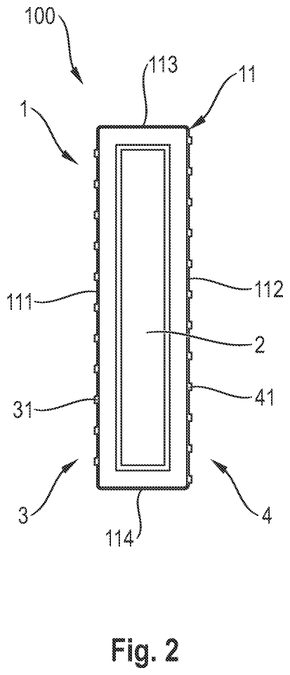

FIG. 1 and FIG. 2 show different illustrations of a battery cell 100 according to aspect of the invention. The battery cell 100 is configured in the shape of an elongated cuboid and comprises a fluid-tight cell housing 1 in which active materials of the battery cell 100 not shown here are located.

The cell housing 1 comprises a housing part 11, which is configured as a hollow extruded profile and has a rectangular cross-section and forms a first side wall 111, a second side wall 112, a third side wall 113 and a fourth side wall 114 of the cell housing 1. The housing part 11 is made of a metal, preferably aluminum.

The cell housing 1 further comprises two lids 12, each of which closes one of the two open end faces of the housing part 11 in a fluid-tight manner. A contact element 2 for electrically contacting the active materials of the battery cell 100 in the cell housing 1 projects from each of the two lids 12.

The first side wall 111 comprises a projecting first spacer structure 3 formed by the first side wall 111 on its outer side, and the second side wall 112 comprises a projecting second spacer structure 4 formed by the second side wall 112 on its outer side. The two spacer structures 3, 4 each comprise a plurality of ribs 31, 41, all of which are configured parallel to a longitudinal axis L of the battery cell 100. Specifically, the first spacer structure 3 comprises eleven ribs 31 and the second spacer structure 4 comprises twelve ribs 41.

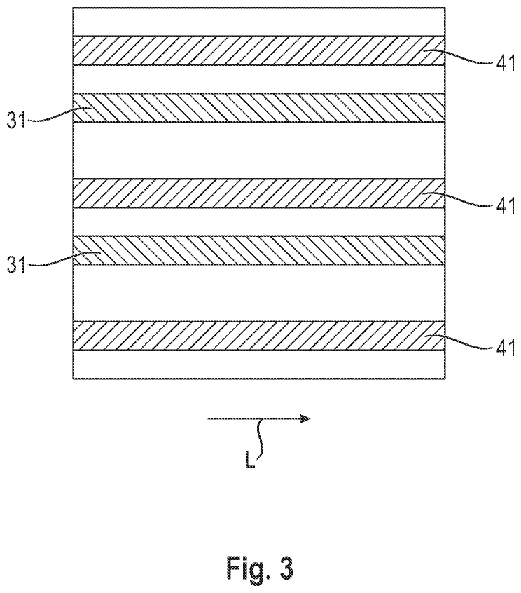

FIG. 3 shows a section of a parallel projection of the two spacer structures 3, 4 onto a projection plane which extends parallel to the outer side of the first side wall 111 and the outer side of the second side wall 112. As can be seen here, the ribs 31 of the first spacer structure 3 and the ribs 41 of the second spacer structure 4 are disposed such that, in the parallel shown projection, ribs 31 of the first spacer structure 3 are located between ribs 41 of the second spacer structure 4.

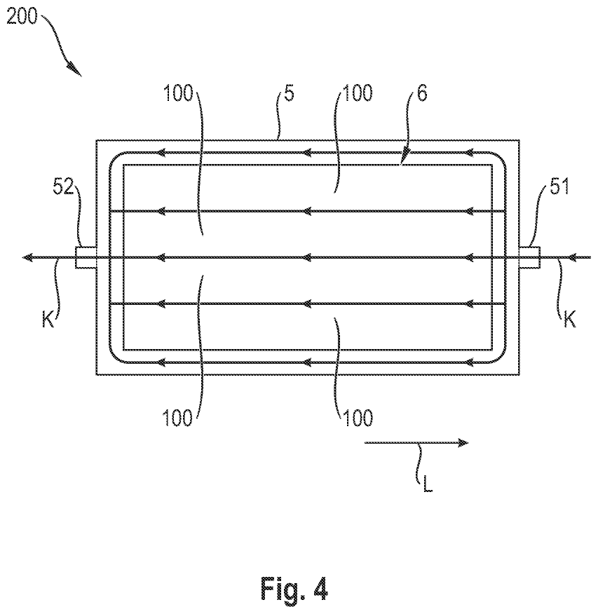

FIG. 4 shows a schematic diagram of a liquid-cooled battery 200 according to aspects of the invention with a battery housing 5 which comprises a cooling liquid inlet 51 and a cooling liquid outlet 52.

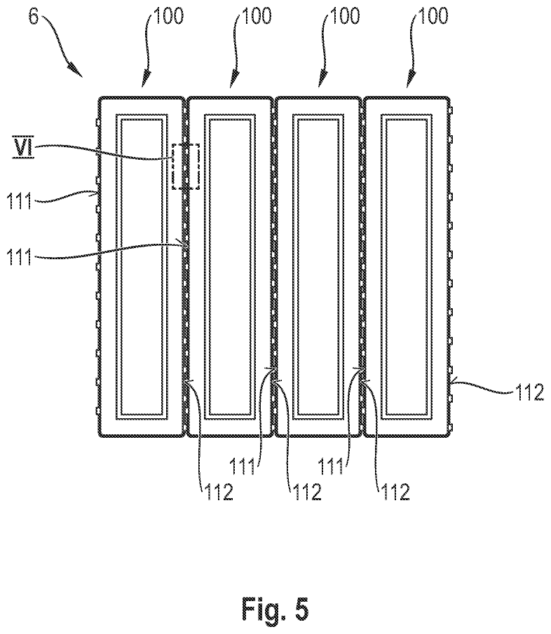

A battery cell stack 6 which comprises four battery cells 100 according to aspects of the invention is disposed in the battery housing 5. The battery cells 100 are stacked in the battery cell stack 6 such that the respective second side wall 112 of a first battery cell 100, for example the first battery cell 100 starting from the left side of FIG. 5, abuts the first side wall 111 of an adjacent second battery cell 100, for example the second battery cell 100 starting from the left side of FIG. 5, so that the second spacer structure 4 of the first battery cell 100 configured on the second side wall 112 of the first battery cell 100 and the first spacer structure 3 of the second battery cell 100 formed on the first side wall 111 of the second battery cell 100 respectively form a plurality of intermediate spaces 7 between two adjacent battery cells 100.

The liquid-cooled battery 200 is configured such that, during operation of the liquid-cooled battery 200, a cooling liquid K, as shown in FIG. 4 via the arrows, can flow from the cooling liquid inlet 51 through the battery housing 5 to the cooling liquid outlet 52, wherein the cooling liquid K can in particular also flow parallel to the longitudinal axis L of the battery cells 100 through the plurality of intermediate spaces 7 respectively formed between two adjacent battery cells 100 by the spacer structures 3, 4 of the two adjacent battery cells 100 to efficiently cool the battery cells 100.

### LIST OF REFERENCE SIGNS

100 Battery cell
1 Cell housing
11 Housing part
111 First side wall
112 Second side wall
113 Third side wall
114 Fourth side wall
12 Lid
2 Contact element
3 First spacer structure
31 Ribs
4 Second spacer structure
41 Ribs
200 Liquid-cooled battery
5 Battery housing
51 Cooling liquid inlet
52 Cooling liquid outlet
6 Battery cell stack
7 Intermediate spaces
K Cooling liquid
L Longitudinal axis

What is claimed is:

1. A battery cell comprising:
a cell housing including a first side wall and a second side wall that is parallel to the first side wall, and
a projecting spacer structure which is formed by one of the side walls and is disposed on an outer side of the first side wall and/or on an outer side of the second side wall.

2. The battery cell according to claim 1, wherein the spacer structure comprises a plurality of parallel ribs.

3. The battery cell according to claim 2, wherein the ribs extend parallel to a longitudinal axis of the battery cell.

4. The battery cell according to claim 1, wherein the projecting spacer structure comprises a first spacer structure disposed on an outer side of the first side wall and a second spacer structure disposed on an outer side of the second side wall.

5. The battery cell according to claim 4, wherein ribs of the first spacer structure are configured parallel to ribs of the second spacer structure and wherein the ribs of the first spacer structure and the ribs of the second spacer structure are disposed such that, in a parallel projection of the two spacer structures onto a projection plane which extends parallel to the outer sides of the two side walls, ribs of the first spacer structure are located between ribs of the second spacer structure.

6. The battery cell according to claim 1, wherein the two side walls are both composed of metal.

7. The battery cell according to claim 6, wherein the two side walls are formed by a single extruded profile.

8. A liquid-cooled battery comprising a plurality of the battery cells according to claim 1, wherein the battery cells are stacked such that the second side wall of a first battery cell abuts the first side wall of an adjacent second battery cell and the spacer structure of the second side wall of the first battery cell and/or the spacer structure of the first side wall of the second battery cell form at least one respective intermediate space between two adjacent battery cells which is configured such that a cooling liquid can flow through said intermediate space during operation.

9. A vehicle comprising the liquid-cooled battery of claim 1.
